(19) United States
(12) Patent Application Publication
(10) Pub. No.: US 2014/0347799 A1
(43) Pub. Date: Nov. 27, 2014

(54) ELECTRONIC APPARATUS

(71) Applicant: KABUSHIKI KAISHA TOSHIBA, Tokyo (JP)

(72) Inventor: Yukiya Ono, Hamura-shi (JP)

(73) Assignee: KABUSHIKI KAISHA TOSHIBA, Tokyo (JP)

(21) Appl. No.: 14/255,850

(22) Filed: Apr. 17, 2014

(30) Foreign Application Priority Data
May 22, 2013 (JP) 2013-107833

(51) Int. Cl. H02J 7/02; G06F 1/16

(52) U.S. Cl. CPC H02J 7/025; G06F 1/1633
USPC 361/679.09; 320/108

(57) ABSTRACT

According to at least one embodiment, an electronic apparatus includes an main body includes an upper surface having a keyboard arranged thereon, and a contactless charging module in a palm rest region on the upper surface, configured to charge an external apparatus proximate to the palm rest region by contactless charging.

### CROSS-REFERENCE TO RELATED APPLICATIONS

This application is based upon and claims the benefit of priority from Japanese Patent Application No. 2013-107833, filed May 22, 2013, the entire contents of which are incorporated herein by reference.

### FIELD

Embodiments described herein relate generally to an electronic apparatus having a charging function or communication function.

### BACKGROUND

Recently, various types of electronic apparatuses such as notebook-type personal computers (PCs) have been developed. Most of the electronic apparatuses have a function to communicate with an external device.

In addition, wearable apparatuses which can be worn on human bodies have also been developed. A user can obtain various types of information from a wearable apparatus while attaching the wearable apparatus to the body.

At charging a wearable apparatus, however, a user needs to intentionally execute several operations necessary for the charging of the wearable apparatus. For example, the user must execute operations such as detaching the wearable apparatus worn on the body, and connecting the wearable apparatus and a cable allowing electric power to be supplied to the detached wearable apparatus.

In addition, to execute communications between a personal computer and the wearable apparatus, the user must intentionally execute operations such as detaching the wearable apparatus worn on the body, and connecting the wearable apparatus to the computer.

For this reason, user's labor of operations necessary to charge an external device such as the wearable apparatus or to execute communications using the external device is required to be decreased.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing an outer appearance of an electronic apparatus according to an embodiment;

FIG. 2 is an exemplary illustration showing an outer appearance of a wearable apparatus connectable to the electronic apparatus according to the embodiment;

FIG. 3 is an exemplary illustration showing the wearable apparatus shown in FIG. 2 attached to a user's wrist;

FIG. 4 is an illustration for explanation of an example of use of the electronic apparatus according to the embodiment;

FIG. 5 is an illustration for explanation of an example of use of the electronic apparatus according to the embodiment;

FIG. 6 is an exemplary block diagram showing a system configuration of the electronic apparatus according to the embodiment;

FIG. 7 is an exemplary illustration showing a relationship between a contactless charging pad and a short-range wireless communication module which are provided in the electronic apparatus according to the embodiment;

FIG. 8 is an exemplary block diagram showing a configuration of a control program executed by the electronic apparatus according to the embodiment;

FIG. 9 is a flow chart showing an example of steps of the control program executed by the electronic apparatus according to the embodiment;

FIG. 10 is a flow chart showing another example of steps of the control program executed by the electronic apparatus according to the embodiment;

FIG. 11 is a flow chart showing the other example of steps of the control program executed by the electronic apparatus according to the embodiment;

FIG. 12 is an exemplary block diagram showing a system configuration of the wearable apparatus shown in FIG. 2; and

FIG. 13 is an illustration showing the other example of use of the electronic apparatus according to the embodiment.

### DETAILED DESCRIPTION

Various embodiments will be described hereinafter with reference to the accompanying drawings.

In general, according to one embodiment, an electronic apparatus includes a main body comprising an upper surface having a keyboard arranged thereon, and a contactless charging module in a palm rest region on the upper surface, configured to charge an external apparatus proximate to the palm rest region by contactless charging.

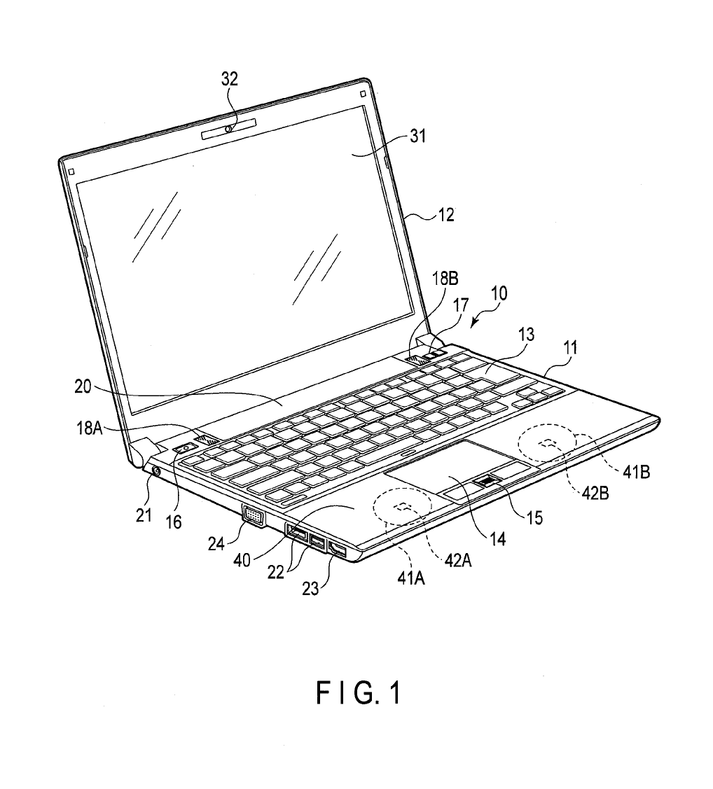

First, a configuration of an electronic apparatus according to a present embodiment will be described with reference to FIG. 1. The electronic apparatus can be implemented as a notebook type personal computer or a convertible personal computer. The convertible personal computer is a computer which can be used in a form applicable to a laptop mode or a form applicable to a tablet mode. It is assumed here that the electronic apparatus is implemented as a notebook type personal computer 10.

FIG. 1 is a perspective view showing the computer 10 having a display unit opened, as seen from a front side. The computer 10 is configured to receive an electric power from a battery 20. The computer 10 comprises a computer body 11 and a display unit 12. A display device such as a liquid crystal device (LCD) 31 is embedded in the display unit 12. A camera (Web camera) 32 is arranged at an upper end portion of the display unit 12.

The display unit 12 is attached to the computer body 11 so as to freely pivot between an opened position at which an upper surface of the computer body 11 is exposed and a closed position at which the upper surface of the computer body 11 is covered with the display unit 12. The computer body 11 comprises a housing shaped in a thin box. A keyboard 13, a touchpad 14, a fingerprint sensor 15, a power switch 16 to power on/off the computer 10, several function buttons 17, and speakers 18A and 18B are arranged on the upper surface of the housing.

The computer body 11 is provided with a power connector 21. The power connector 21 is arranged on a side surface, for example, a left side surface of the computer body 11. An external power supply device is detachably connected to the power connector 21. An AC adapter can be used as the external power supply device. The AC adapter is a power supply device configured to convert a commercial power (AC power) into DC power.

The battery 20 is detachably mounted on, for example, a rear end portion of the computer body 11. The battery 20 may be a battery built in the computer 10.

The computer 10 is driven by an electric power from an external power supply or an electric power from the battery 20. If the external power supply is connected to the power connector 21 of the computer 10, the computer 10 is driven by the electric power from the external power supply. The electric power from the external power supply is also used to charge the battery 20. The computer 10 is driven by the electric power from the battery 20 while the external power supply is not connected to the power connector 21 of the computer 10.

The computer body 11 is further provided with several USB ports 22, an HDMI (Registered Trademark) (High-definition multimedia interface) output terminal 23 and an RGB port 24.

In addition, the upper surface of the computer body 11 has a palm rest region. The touchpad 14, contactless charging pads 41A and 41B, and communication modules 42A and 42B for short-range wireless communication are arranged in the palm rest region 40. The palm rest region 40 is positioned between the keyboard 13 and a front end portion of the computer body 11 as shown in FIG. 1.

The contactless charging pads 41A and 41B are arranged on both sides of the touchpad 14 as shown in FIG. 1. Similarly, communication modules 42A and 42B for short-range wireless communication are also arranged on both sides of the touchpad 14.

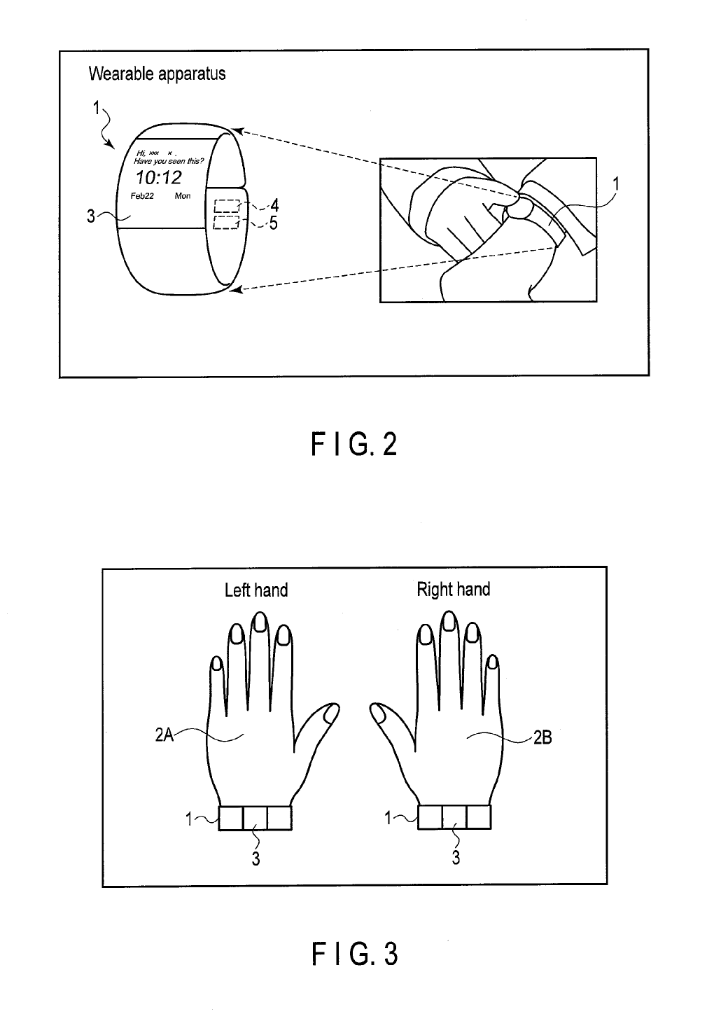

The contactless charging pads 41A and 41B implement contactless charging (i.e., wireless feeding) of an external apparatus proximate to the palm rest region 40. The external apparatus is, for example, a wearable apparatus which can be worn on a user's wrist as described later with reference to FIG. 2. It is assumed here that the external apparatus is the wearable apparatus. The contactless charging indicates charging in a contactless method. The contactless charging is, for example, the charging in an electromagnetic induction method utilizing the principle of electromagnetic induction, a magnetic resonance method utilizing resonance phenomenon, a microwave reception method utilizing microwaves received by an antenna as the electric power, etc.

The communication modules 42A and 42B for short-range wireless communication are used for the short-range wireless communication with the wearable apparatus proximate to the palm rest region 40. The short-range wireless communication is, for example, NFC (Near Field Communication). Each of the communication modules 42A and 42B for short-range wireless communication may be a short-range wireless communication module configured to execute the short-range wireless communication corresponding to the NFC or an antenna electrically connected to the short-range wireless communication module.

Each of the contactless charging pads 41A and 41B and the communication modules 42A and 42B may be arranged at a position closer to the front end portion of the computer body 11 than to a middle portion between the keyboard 13 and the computer body 11. The wearable apparatus worn on the user's wrist can easily be thereby proximate to the contactless charging pads 41A and 41B and the communication modules 42A and 42B when the user operates the keyboard 13. Since the contactless charging pads 41A and 41B and the communication modules 42A and 42B are arranged on both sides of the touchpad 14, the wearable apparatus can be set to be proximate to the contactless charging pads or the communication modules even if the wearable apparatus is worn on the left wrist or the right wrist.

Each of the contactless charging pads 41A and 41B may be arranged on the palm rest region 40 such that upper surfaces of the contactless charging pads 41A and 41B are exposed or may be provided inside the computer body 11 such that the upper surfaces of the contactless charging pads 41A and 41B are opposite to the palm rest region 40. Similarly, each of the communication modules 42A and 42B may be arranged on the palm rest region 40 such that upper surfaces of the communication modules 42A and 42B are exposed or may be provided inside the computer body 11 such that the upper surfaces of the communication modules 42A and 42B are opposite to the palm rest region 40.

In addition, the contactless charging pads 41A and 41B and the communication modules 42A and 42B do not need to be arranged on the palm rest region 40 of the computer 10, but either the contactless charging pads 41A and 41B or the communication modules 42A and 42B may be arranged on the palm rest region 40.

FIG. 1 shows a structure in which the contactless charging pads 41A and 41B are arranged on both of the right and left sides of the touchpad 14. However, the contactless charging pads may be arranged on either the left side or the right side of the touchpad 14. Similarly, the communication modules may be arranged on either the left side or the right side of the touchpad 14. In other words, a configuration of comprising the contactless charging pad 41A and the communication module 42A arranged on the left side of the touchpad 14 or a configuration of comprising the contactless charging pad 41B and the communication module 42B arranged on the right side of the touchpad 14 may be employed. In this case, too, the user wearing the wearable apparatus on the left wrist or the right wrist can charge the wearable apparatus by contactless charging and can execute the short-range wireless communication between the wearable apparatus and the computer 10, while operating the keyboard 13.

Next, a summary of a wearable apparatus 1 will be described with reference to FIG. 2.

The wearable apparatus 1 is an apparatus which can be worn on a human body. The wearable apparatus 1 is, for example, a watch type (bracelet type) apparatus which can be worn on the user's wrist, a simple apparatus which does not comprise a display unit such as a display and which can be worn on the user's wrist, an eyeglass type apparatus which can be employed as eyeglasses, or the like. It is hereinafter assumed that the wearable apparatus 1 is implemented as the watch type (bracelet type) apparatus.

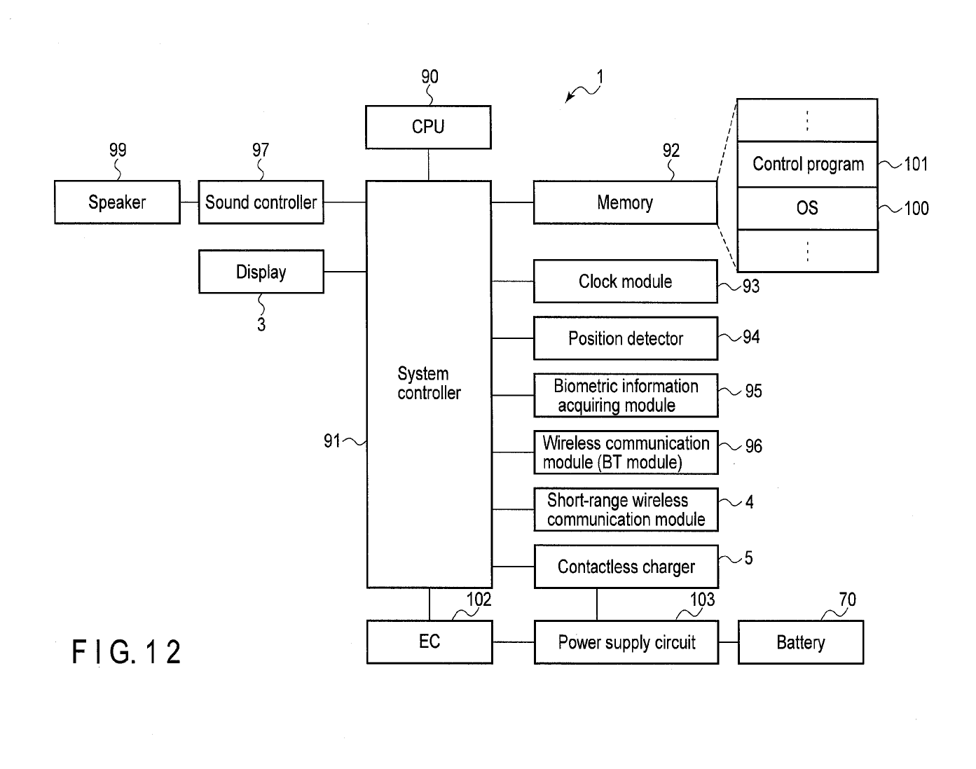

The wearable apparatus 1 comprises a display 3, a short-range wireless communication module 4, and a contactless charger 5. The short-range wireless communication module 4 and the contactless charger 5 may be provided at a belt portion of the wearable apparatus 1 so as to be positioned oppositely to the display 3 in view of the user's wrist in a state in which the wearable apparatus 1 is worn on the user's wrist. A detailed system configuration of the wearable apparatus 1 will be described later with reference to FIG. 12.

The wearable apparatus 1 has a predetermined function to provide the user wearing the wearable apparatus 1 with various elements of information. Furthermore, the wearable apparatus 1 has a contactless charging function to execute the contactless charging of a battery (i.e., secondary battery) in the wearable apparatus 1 and a short-range wireless communication function to execute the short-range wireless communication function.

The wearable apparatus 1 can charge the battery in the wearable apparatus 1 by electric power fed from the contactless charging pad 41A or 41B by wireless feeding. When the contactless charging pad 41A or 41B approaches the contactless charger 5 of the wearable apparatus 1, the contactless charging pad 41A or 41B and the contactless charger 5 are electromagnetically combined with each other and the battery in the wearable apparatus 1 is charged by the contactless charging. When the state of proximity between the wearable apparatus 1 and the contactless charging pad 41A or 41B is canceled, the coupling between the pad 41A or 41B and the contactless charger 5 is also canceled and the contactless charging of the battery in the wearable apparatus 1 is stopped.

The wearable apparatus 1 can execute the short-range wireless communication with the computer 10. The wearable apparatus 1 can synchronize data stored in the wearable apparatus 1 and data stored in the computer 10 with each other by the short-range wireless communication (i.e., synchronizing function). For example, the wearable apparatus 1 can synchronize user's schedule data stored in the computer 10 and user's schedule data stored in the wearable apparatus 1 with each other.

The wearable apparatus 1 has a function to provide an owner with various elements of information related to the user which is an owner of the wearable apparatus 1. Various elements of information related to the user are, for example, schedule information, weather information, position information of the wearable apparatus 1, traffic information, etc. The schedule information is, for example, schedule data synchronized by the short-range wireless communication function.

FIG. 3 shows the wearable apparatus 1 worn on the user's wrist. The wearable apparatus 1 is worn on the user's right wrist or left wrist. A left part of FIG. 3 shows the wearable apparatus 1 worn on the left wrist and a right part of FIG. 3 shows the wearable apparatus 1 worn on the right wrist. The wearable apparatus 1 is worn on the left wrist or the right wrist such that a back of a left hand 2A or a right hand 2B and the display 3 are on the same side as shown in FIG. 3. When the wearable apparatus 1 is thus worn on the wrist, the short-range wireless communication module 4 and the contactless charger 5 are positioned on a palm side of the left hand 2A or the right hand 2B.

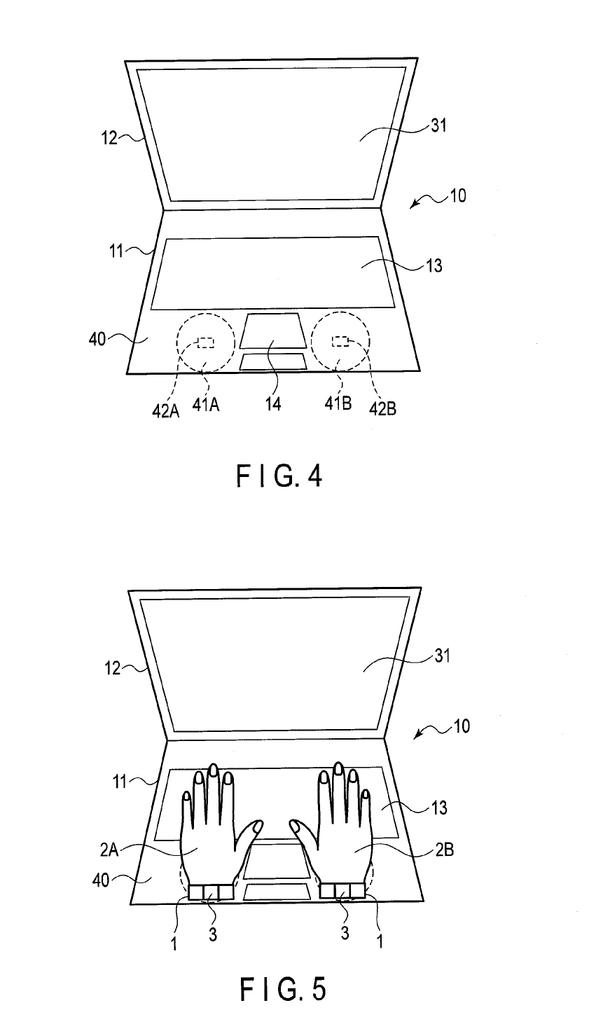

Next, a summary of the embodiment will be described with reference to FIG. 4 and FIG. 5.

FIG. 4 is an illustration of the computer 10 seen from a front side. FIG. 5 is an illustration of the computer 10 used by the user.

As described above, in the computer 10, the contactless charging pads 41A and 41B are provided on both the sides of the touchpad 14, respectively, and the communication modules 42A and 42B are further provided on both the sides of the touchpad 14, respectively. When the user uses the computer 10, the wearable apparatus 1 approaches each of the short-range wireless communication module and the contactless charging pads even if the wearable apparatus 1 is worn on either the left wrist or the right wrist as shown in FIG. 5. For this reason, for example, when the user operates the keyboard 13, the wearable apparatus 1 is automatically charged. In addition, for example, when the user operates the keyboard 13, short-range wireless communication is automatically executed between the wearable apparatus 1 and the computer 10. For this reason, the user can unconsciously execute the charging of the wearable apparatus 1 and short-range wireless communication between the wearable apparatus 1 and the computer 10.

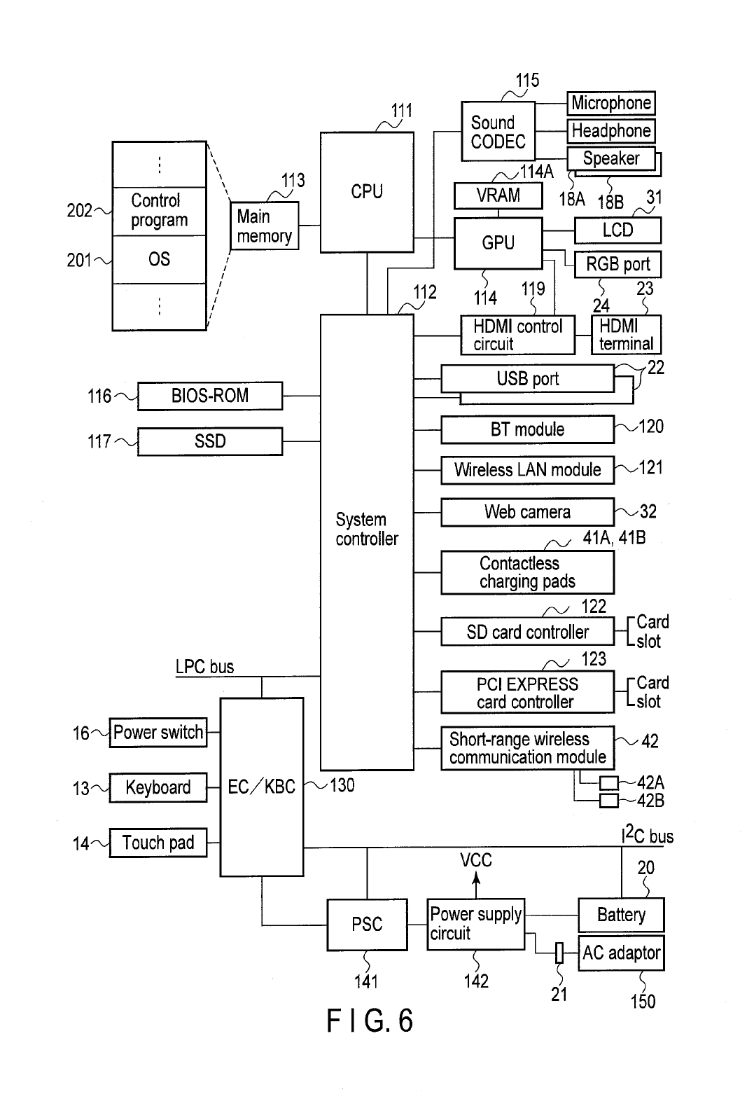

FIG. 6 shows a system configuration of the computer 10. It is assumed that the above-described communication modules 42A and 42B are antennas for the short-range wireless communication module in the system configuration in FIG. 6.

The computer 10 includes the contactless charging pads 41A and 41B, a short-range wireless communication module 42, a CPU 111, a system controller 112, a main memory 113, a graphics processing unit (GPU) 114, a sound codec 115, a BIOS-ROM 116, a solid state drive (SSD) 117, a BT (Bluetooth (registered trademark)) module 120, a wireless LAN module 121, an SD card controller 122, a PCI EXPRESS card controller 123, an embedded controller/keyboard controller IC (EC/KBC) 130, a power supply controller (PSC) 141, a power supply circuit 142, etc.

The CPU 111 is a processor which controls operations of respective components of the computer 10. The CPU 111 executes various types of software loaded from the SSD 117 onto the main memory 113. The software includes an operating system (OS) 201 and various types of application programs. The application programs include a control program 202. The control program 202 is a program which provides various functions in cooperation with the wearable apparatus 1. For example, the control program 202 can execute a function to cause data synchronization between the computer 10 and the wearable apparatus 1 using the short-range wireless communication, a function to control locking/unlocking of the computer 10, a function to control validation/invalidation of the touchpad 14, etc.

In addition, the CPU 111 also executes a basic input output system (BIOS) stored in the BIOS-ROM 116 which is a nonvolatile memory. The BIOS is a system program for hardware control.

The GPU 114 is a display controller which controls the LCD 31 employed as a display monitor of the computer 10. The GPU 114 generates a display signal (i.e., LVDS signal) which should be supplied to the LCD 31 from display data stored in a video memory (VRAM) 114A. Furthermore, the GPU 114 can also generate an analog RGB signal and an HDMI signal from the display data. The analog RGB signal is supplied to an external display via the RGB port 24. An HDMI output terminal 23 can send an HDMI video signal (i.e. uncompressed digital image signal) and a digital audio signal to the external display by means of a cable. An HDMI control circuit 119 is an interface which sends the HDMI video signal and the digital audio signal to the external display via the HDMI output terminal 23.

The system controller 112 is a bridge device which makes connection between the CPU 111 and each of the components. A serial ATA controller which controls the SSD 117 is built in the system controller 112. The system controller 112 executes communication with each of the devices on an LPC (Low PIN Count) bus.

The EC/KBC 130 is connected to the LPC bus. The EC/KBC 130, the power supply controller (PSC) 141 and the battery 20 are interconnected via a serial bus such as an I²C bus.

The EC/KBC 130 is a power management controller which executes power management of the computer 10 and is implemented as a one-chip microcomputer in which, for example, a keyboard controller configured to control the keyboard (KB) 13, the touchpad 14, etc. is built. The EC/KBC 130 has a function to power on and off the computer 10 in response to a user's operation of the power switch 16. The control to power on and off the computer 10 is executed by a cooperative operation of the EC/KBC 130 and the power supply controller (PSC) 141. When the power supply controller (PSC) 141 receives an ON signal sent from the EC/KBC 130, the power supply controller (PSC) 141 controls the power supply circuit 142 to power on the computer 10. In addition, when the power supply controller (PSC) 141 receives an OFF signal sent from the EC/KBC 130, the power supply controller (PSC) 141 controls the power supply circuit 142 to power off the computer 10. The EC/KBC 130, the power supply controller (PSC) 141 and the power supply circuit 142 also operate with the electric power from the battery 20 or an AC adapter 150 over a period in which the computer 10 is powered off.

The power supply circuit 142 generates the electric power (operational power supply) which should be supplied to each of the components, by using the electric power from the battery 20 or the electric power from the AC adaptor 150 connected to the computer body 11 as the external power supply.

The contactless charging pads 41A and 41B can charge the wearable apparatus 1 by the contactless charging (i.e., wireless feeding) using the electric power supplied from the power supply circuit 142. The contactless charging pads 41A and 41B may be connected with the system controller 112. In this case, the contactless charging function may be validated or invalidated in response to an instruction from the OS 201, etc.

The short-range wireless communication module 42 executes short-range wireless communication with the wearable apparatus 1 proximate to the palm rest region. The short-range wireless communication module 42 is an NFC device and is connected to the above-described communication modules 42A and 42B serving as NFC antennas.

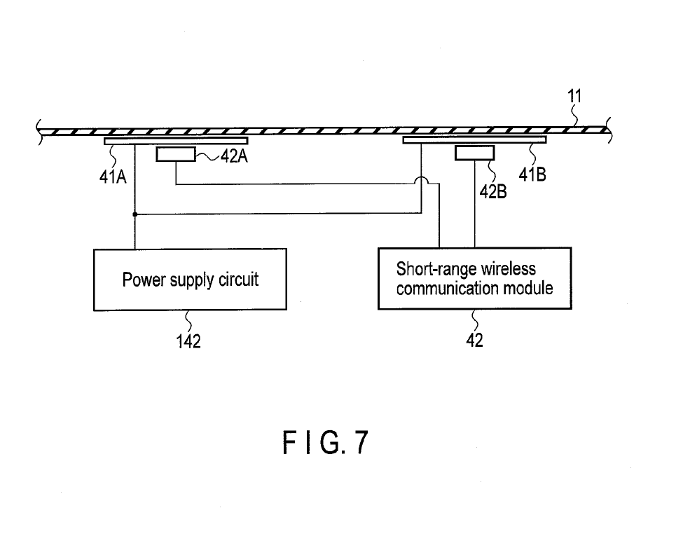

FIG. 7 shows an example of arrangement of the contactless charging pads 41A and 41B, and the short-range wireless communication modules 42A and 42B. It is assumed here that the short-range wireless communication modules 42A and 42B are antennas and that the contactless charging pads 41A and 415 and the short-range wireless communication modules 42A and 42B are provided in the computer body 11 under the palm rest 40.

The contactless charging pad 41A is a first contactless charging portion, which is connected with the power supply circuit 142. The contactless charging pad 41A includes, for example, a coil, etc. to be used for the contactless charging. The contactless charging pad 41B is a second contactless charging portion, which is connected with the power supply circuit 142. The contactless charging pad 41B also includes, for example, a coil, etc. to be used for the contactless charging. The power supply circuit 142 supplies the electric power necessary for the contactless charging to the contactless charging pads 41A and 41B.

The short-range wireless communication modules (antennas) 42A and 42B are electrically connected with the short-range wireless communication module 42. The short-range wireless communication module 42 executes short-range wireless communication with an external device proximate to the short-range wireless communication module (antenna) 42A or the short-range wireless communication module (antenna) 42B.

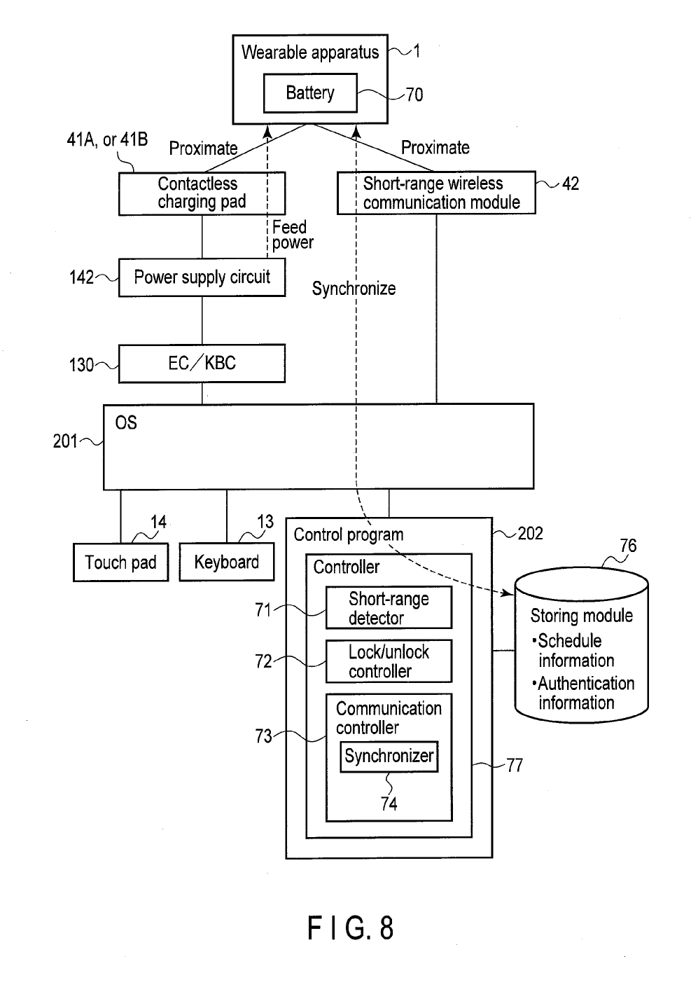

Next, a configuration of a system including the control program 202 will be described with reference to FIG. 8.

The control program 202 includes a controller 77. The controller 77 includes a short-range detector 71, a lock/unlock controller 72 and a communication controller 73.

The control program 202 executes processing in cooperation with the OS 201, etc. The OS 201 includes a driver program which controls the short-range wireless communication module 42, etc.

The short-range detector 71 detects the wearable apparatus 1 being proximate to the palm rest region (i.e., proximate state) or not proximate to the palm rest region (i.e. non-proximate state) by cooperating with the above-described driver program.

The lock/unlock controller 72 unlocks the computer 10 under a condition that the wearable apparatus 1 is a predetermined apparatus, if the wireless connection between the wearable apparatus 1 and the short-range wireless communication module 42 is estimated in a state in which the computer 1 is locked. The predetermined apparatus is, for example, an apparatus preliminarily registered in association with the computer 10. In more detail, the lock/unlock controller 72 discriminates whether the wearable apparatus 1 is the predetermined apparatus or not, based on authentication information stored in a storing module 76. More specifically, the lock/unlock controller 72 obtains an authentication ID, etc. from the wearable apparatus 1 and discriminates whether the wearable apparatus 1 is the predetermined apparatus or not, depending on whether the obtained authentication ID is included in the authentication information stored in the storing module 76 or not.

In addition, if a state in which the wearable apparatus 1 which is the predetermined apparatus is not proximate to the palm rest region 40 is maintained for a predetermined period, the lock/unlock controller 72 sets the computer 10 to be in a locked state. If the proximate state of the wearable apparatus 1 and the palm rest region 40 is canceled, the wireless connection between the wearable apparatus 1 and the short-range wireless communication module 42 is interrupted. The lock/unlock controller 72 sets the computer 10 to be in a locked state after a predetermined period has elapsed since the cancellation of the proximate state of the wearable apparatus 1 and the palm rest region 40, i.e., since interrupting of the wireless connection between the wearable apparatus 1 and the short-range wireless communication module 42. The predetermined period is, for example, approximately one minute. In more detail, the lock/unlock controller 72 starts measurement of the predetermined period after, for example, it is detected by the short-range detector 71 that the wearable apparatus 1 is not proximate to the palm rest region. When the predetermined period has elapsed, the lock/unlock controller 72 instructs the OS 201 to lock the computer 10. The OS 201 displays, for example, an input screen to urge the user to input a password, etc. on the LCD 31, etc.

In addition, if the wireless connection between the wearable apparatus 1 and the short-range wireless communication module 42 is established in a state in which the computer 10 is locked, the lock/unlock controller 72 controls authentication to unlock the computer 10 under a condition that the wearable apparatus 1 is the predetermined apparatus.

In addition, if a state in which the wearable apparatus 1 which is the predetermined apparatus is not proximate to the palm rest region is maintained for a predetermined period, the lock/unlock controller 72 sets the computer 10 to be in a locked state.

The communication controller 73 includes a synchronizer 74. If the wearable apparatus 1 is in close vicinity, the communication controller 73 executes control for the short-range wireless communication with the wearable apparatus 1 via the short-range wireless communication module 42. The synchronizer 74 synchronizes data of schedule information stored in the storing module 76 provided in the computer 10 and data of schedule information stored in the wearable apparatus 1 with each other by using the short-range wireless communication.

For example, the SSD 117 is assumed as the storing module 76, but the storing module 76 may be a storage medium which is not built in the computer 10, such as an SD card to be inserted into an SD card slot, etc.

The controller 77 invalidates the touchpad 14 over a period in which the wearable apparatus 1 is proximate to the palm rest region 40. Thus, for example, when the user operates the keyboard 13, a hypersensitive reaction caused by a careless touch of a user's finger on the touchpad 14 or the like can be prevented.

On the other hand, the contactless charging pads 41A and 41B charges a battery 70 provided in the wearable apparatus 1 by contactless charging using the electric power supplied from the power supply circuit 142. When the contactless charging pads 41A and 41B is physically in close vicinity to the wearable apparatus 1, the contactless charging pad 41A or 41B and the wearable apparatus 1 are electromagnetically coupled to each other and the contactless charging is thereby started.

The control program 202 may be mounted as a service of the OS 201.

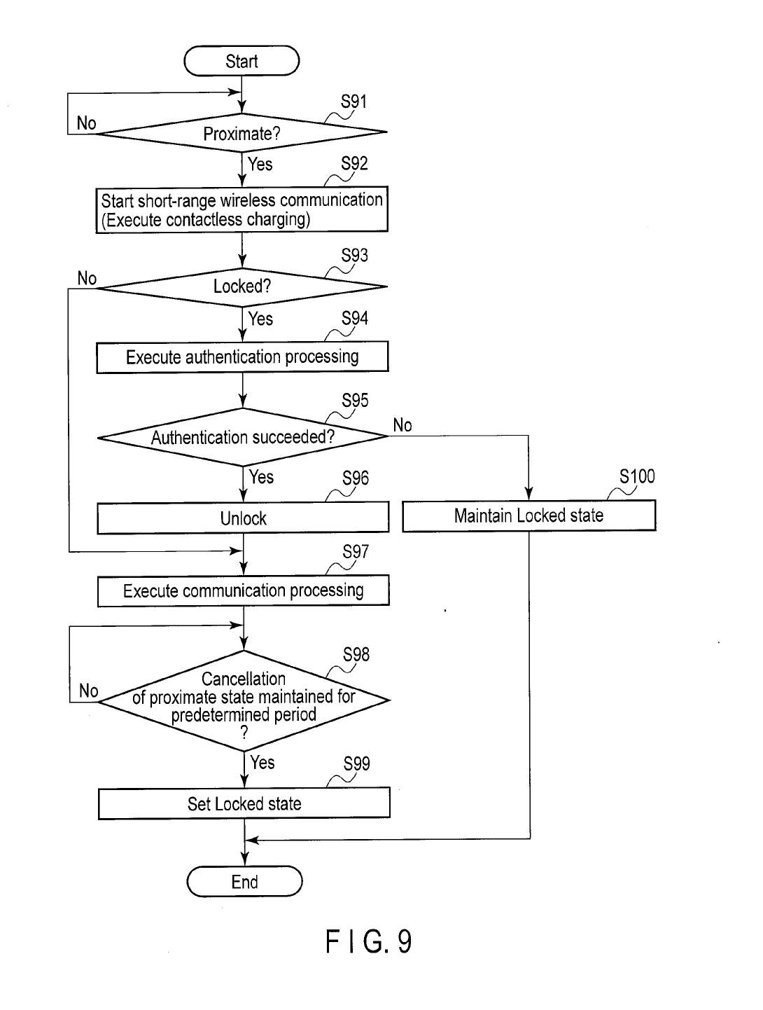

Next, steps of close-vicinity wireless communication processing of the embodiment will be described with reference to FIG. 9.

First, the control program 202 discriminates whether the external apparatus such as the wearable apparatus 1, and the communication module 42A or 42B of the palm rest region 40 are proximate to each other or not (step S91). If the user wearing the wearable apparatus 1 places its hand on the palm rest region 40, the wearable apparatus 1 and the communication module 42A or 428 become proximate. If the control program 202 discriminates that the wearable apparatus 1 and the communication module 42A or 42B become proximate (YES in step S91), the control program 202 starts the short-range wireless communication (step S92). In this case, since the wearable apparatus 1 and the contactless charging pad 41A or 41B also become proximate, the electric power is supplied from the contactless charging pad 41A or 41B to the wearable apparatus 1 by the contactless feeding. The wearable apparatus 1 starts charging the battery inside the wearable apparatus 1 by using the electric power supplied from the contactless charging pad 41A or 41B.

The control program 202 discriminates whether the computer 10 is in a locked state or not (step S93). If the control program 202 discriminates that the computer 10 is locked (YES in step S93), the control program 202 executes the above-described authentication processing (step S94). The control program 202 discriminates whether the authentication processing is succeeded or not (step S95). If the authentication processing is succeeded, i.e., if the wearable apparatus 1 proximate to the computer 10 is a preliminarily registered apparatus (YES in step S95), the control program 202 unlocks the computer 10 and sets the computer 10 to be operable for the user (step S96). Then, the control program 202 executes data communication such as data synchronization between the computer 10 and the wearable apparatus 1 by the short-range wireless communication (step S97). If the authentication processing is failed (NO in step S95), the control program 202 maintains the locked state of the computer 10 (step S100). If the control program 202 discriminates that the computer 10 is not in the locked state, i.e., unlocked state in the processing of step S93 (NO in step S93), the control program 202 executes data communication between the computer 10 and the wearable apparatus 1 by the short-range wireless communication (step S97).

The control program 202 may start the short-range wireless communication in step S92 and then execute the data communication adopting the short-range wireless communication in step S97 without executing the processing in steps S93 to S96.

When the state of proximity between the wearable apparatus 1 and the short-range wireless communication module 42A or 42B of the palm rest region 40 is cancelled, the wireless communication between the wearable apparatus 1 and the computer is canceled and the data communication adopting the short-range wireless communication is thereby stopped. In this case, since the electromagnetic coupling between the wearable apparatus 1 and the contactless charging pad 41A or 41B of the palm rest region 40 is also cancelled, the contactless charging is stopped.

The control program 202 discriminates whether the cancellation of the state of proximity between the wearable apparatus 1 and the communication module 42A or 42B of the palm rest region 40 has been continued for a predetermined period or not (step S98). The predetermined period is, for example, one minute as described above. If the state of proximity has been continued for the predetermined period (YES in step S98), the control program 202 sets the computer 10 to be locked (step S99). If the user's hand is placed on the palm rest region before the state of proximity is continued for predetermined period, the wearable apparatus 1 and the communication module 42A or 42B become in the proximate state again and the short-range wireless communication is started.

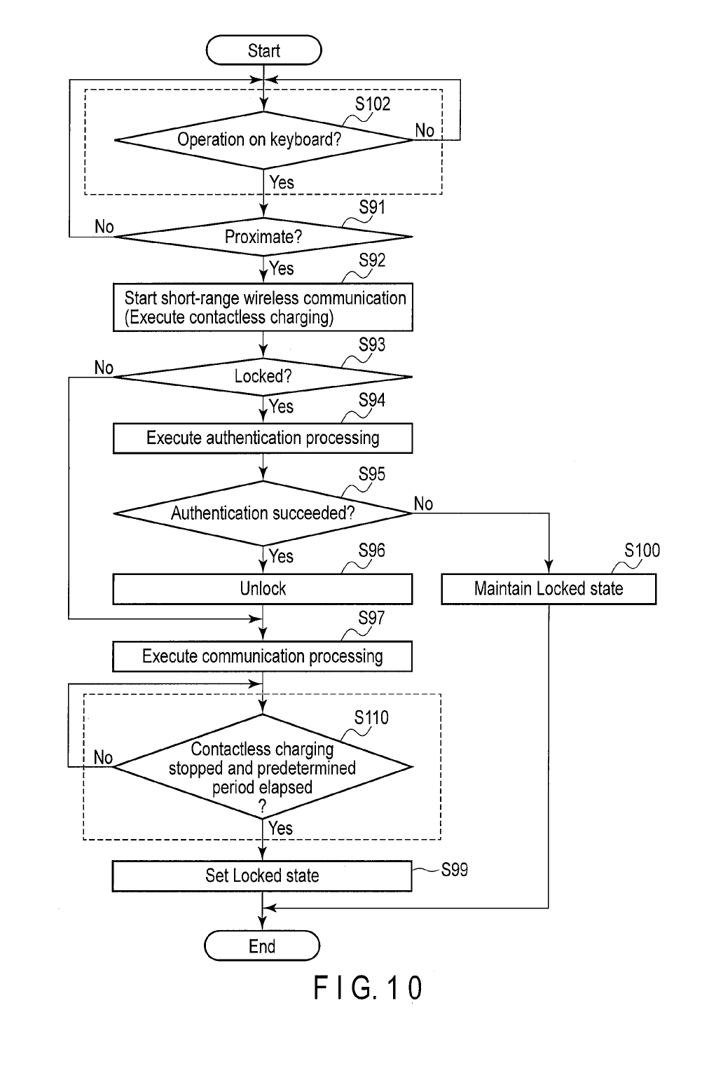

Another example of steps of the short-range wireless communication processing according to the embodiment will be described with reference to FIG. 10. Descriptions on the same processing steps as those of the short-range wireless communication processing described with reference to FIG. 9 are omitted here.

In the processing steps shown in FIG. 10, the control program 202 executes the processing in step S102 prior to the processing in step S91, and executes processing in step S110 instead of the processing in step S98.

First, the control program 202 discriminates whether the operation of the keyboard 13 has been executed by the user or not (step S102). If the control program 202 discriminates that the operation of the keyboard 13 has been executed (YES in step S102), the processing proceeds to step S91. If the control program 202 discriminates that the operation of the keyboard 13 has not been executed (NO in step S102), the control program 202 stands by until the operation of the keyboard 13 is executed.

In addition, the control program 202 discriminates whether stop of the charging of the wearable apparatus 1 has been continued for a predetermined period or not, after the above-described data communication adopting the short-range wireless communication has been executed in step S97 or when the above-described data communication adopting the short-range wireless communication is executed in step S97 (step S110). As described above, the contactless charging is started when the wearable apparatus 1 is physically proximate to the contactless charging pad 41A or 41B, and is stopped when the wearable apparatus 1 is not physically proximate to the contactless charging pad 41A or 41B. For this reason, the control program 202 may discriminate whether the contactless charging has been stopped based on the BIOS, OS 201 or the information obtained from the EC/KBC 130, etc., for example, in step S110.

If the control program 202 discriminates that the stop of the charging of the wearable apparatus 1 has been continued for a predetermined period (YES in step S110), the control program 202 sets the computer 10 to be locked (step S99). In this case, since the wearable apparatus 1 and the communication unit 42A or 42B are not proximate to each other, either, the data communication adopting the short-range wireless communication between the wearable apparatus 1 and the communication unit 42A or 42B is also stopped.

In the processing steps shown in FIG. 10, the control program 202 may not execute the processing in step S102. In addition, the control program 202 may execute the processing in step S102 and may execute the processing in step S98 instead of the processing in step S110.

By executing the processing as shown in FIG. 10, the computer 10 can be used during a period of charging the wearable apparatus 1. In addition, even in a temporarily non-proximate state such as a state in which the user temporarily moves the wrist away from the computer 10, it is possible to prevent the computer 10 from being set to be locked. Since the user who is not notified that the computer 10 cannot be used without charging the wearable apparatus 1 is unable to use the computer 10, security can be increased.

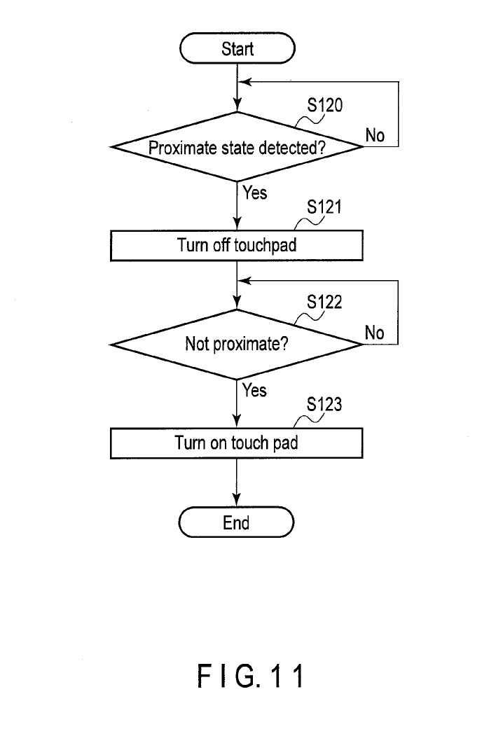

Next, steps of the control program of the touchpad 14 according to the embodiment will be described with reference to FIG. 11.

First, the control program 202 discriminates whether the wearable apparatus 1, and the contactless charging pads 41A and 41B are proximate to each other or not (step S120). If the control program 202 discriminates that the wearable apparatus 1, and the contactless charging pads 41A and 41B are proximate to each other (YES in step S120), the control program 202 sets the touchpad 14 to be turned off (step S121). Turning off the touchpad 14 indicates a state in which, for example, the user's operation on the touchpad 14 is invalid. If the wearable apparatus 1, and the contactless charging pads 41A and 41B are not proximate to each other (NO in step S120), the control program 202 stands by until detecting that the wearable apparatus 1, and the contactless charging pads 41A and 41B are proximate to each other.

Next, the control program 202 discriminates whether the wearable apparatus 1, and the contactless charging pads 41A and 41B are non-proximate to each other or not (step S122). If the control program 202 discriminates that the wearable apparatus 1, and the contactless charging pads 41A and 41B are non-proximate to each other (YES in step S122), the control program 202 sets the touchpad 14 to be turned on (step S123). Turning on the touchpad 14 indicates a state in which, for example, the user's operation on the touchpad 14 is valid. If the control program 202 discriminates that the wearable apparatus 1, and the contactless charging pads 41A and 41B are not non-proximate to each other, i.e. the wearable apparatus 1, and the contactless charging pads 41A and 41B are proximate to each other (NO in step S122), the control program 202 stands by until detecting that the wearable apparatus 1, and the contactless charging pads 41A and 41B are non-proximate to each other.

In step S120, the control program 202 may discriminate whether the wearable apparatus 1, and communication module 42A or 42B are proximate to each other or not. In step S122, the control program 202 may discriminate whether the wearable apparatus 1, and communication module 42A or 42B are non-proximate to each other or not.

The touchpad 14 may be turned on or off by handling the start of the contactless charging or the start of the short-range wireless communication as a trigger.

Next, a system configuration of the wearable apparatus 1 will be described with reference to FIG. 12.

The wearable apparatus 1 includes the short-range wireless communication module 4, the contactless charger 5, the battery 70, a CPU 90, a system controller 91, a memory 92, a clock module 93, a position detector 94, a biometric information acquiring module 95, a wireless communication module (BT module) 96, a sound controller 97, the display 3, a speaker 99, an EC 102, a power supply circuit 103, etc.

The CPU 90 is a processor which controls operations of respective components in the wearable apparatus 1. The CPU 90 executes an operating system (OS) 100 and various application programs loaded onto the memory 92. The application programs include a control program 101.

The control program 101 is a program designed to provide various functions in cooperation with the computer 10. For example, the control program 101 can execute a function for data synchronization between the computer 10 and the wearable apparatus 1 by using the short-range wireless communication, etc.

The system controller 91 is a bridge device which makes connection between the CPU 90 and each of the components. A memory controller which controls an access to the memory 92 is also built in the system controller 91. A display controller which controls the display 3 of the wearable apparatus 1 may also be built in the system controller 91. Furthermore, the system controller 91 also has a function to execute communication with the sound controller 97.

The sound controller 97 is a sound source device configured to output audio data to be reproduced to the speaker 99. The wireless communication module (BT module) 96 is a wireless communication device configured to execute the wireless communication based on, for example, Bluetooth.

The clock module 93 is a module configured to count a current time. The position detector 94 acquires a current position of the wearable apparatus 1, for example, a latitude and a longitude indicating the current position of the wearable apparatus 1. The position detector 94 corresponds to, for example, a global positioning system (GPS).

The biometric information acquiring module 95 includes at least one sensor configured to detect user's biometric information, and can acquire the user's biometric information by using the at least one sensor.

The short-range wireless communication module 4 executes the short-range wireless communication with the computer 10. The short-range wireless communication is, for example, NFC (Near Field Communication).

The contactless charger 5 charges the battery 70 by the electric power supplied by wireless feeding from the proximate computer 10.

The EC 102 is a power management controller configured to execute electric power management of the wearable apparatus 1. The EC 102 and the power supply circuit 103 operate by the electric power from the battery 70 over a period in which the wearable apparatus 1 is powered off.

The power supply circuit 103 can generate an electric power (operational power supply) to be supplied to each of the components by the electric power from the battery 70 or the electric power supplied by wireless feeding from the computer 10.

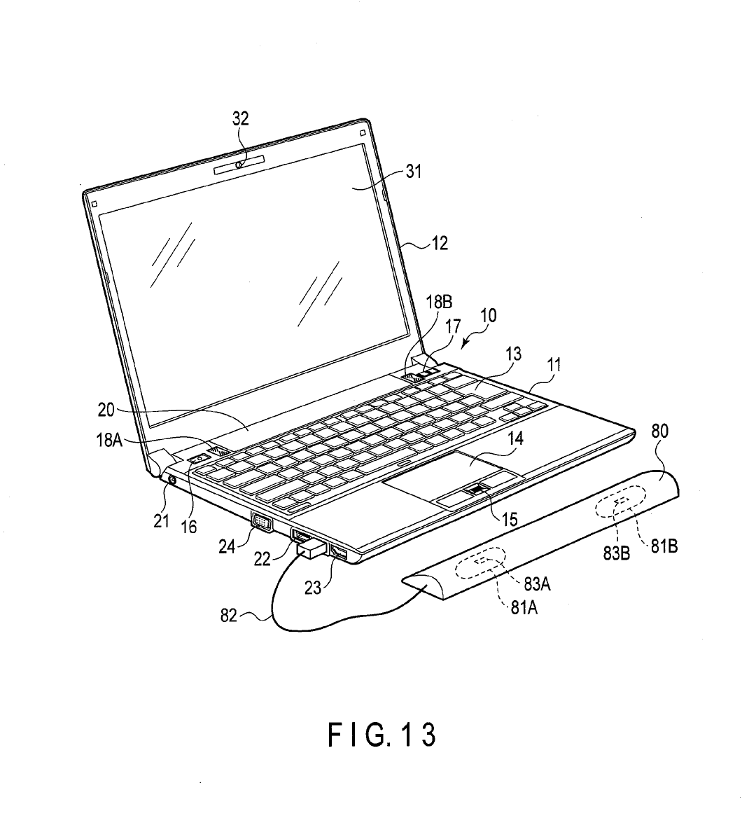

Next, another example of use of the computer 10 according to the present embodiment will be described with reference to FIG. 13. Descriptions on the same function and structure as those of the computer 10 described with reference to FIG. 1 are omitted here.

As shown in FIG. 13, a wrist rest 80 is connected with a USB port 22 of the computer 10 by means of a USB cable 82. The wrist rest 80 includes contactless charging pads 81A and 81B, and communication modules 83A and 83B for short-range wireless communication. The contactless charging pads 81A and 81B and the communication modules 83A and 83B for short-range wireless communication may be built in the wrist rest 80 or may be arranged on an upper surface portion of the wrist rest 80.

The wrist rest 80 is arranged at a position which the wearable apparatus 1 worn on the user's wrist, etc. approaches when the user uses the computer 10. For example, the wrist rest 80 is arranged at a position which is proximate to the wearable apparatus 1 worn on the user's wrist, etc. when the user executes an input operation on the keyboard 13. The user can freely change the position of the wrist rest 80 relative to the position of the computer 10.

The contactless charging pads 81A and 81B supply electric power supplied from the computer 10 by means of the USB cable 82, to the proximate wearable apparatus 1, by the wireless feeding.

In addition, when the wrist rest 80 is used as shown in FIG. 13, the contactless charging pads 41A and 41B and the short-range wireless communication module 42 are connected to the USB port 22 as shown in FIG. 6.

If the wrist rest 80 includes the contactless charging pads 81A and 81B and the communication modules 83A and 83B for short-range wireless communication as shown in FIG. 13, the above-described contactless charging function, short-range wireless communication, etc. can also be executed on, for example, a desktop computer which does not have the palm rest 40, etc.

As the computer 10 as described above, a foldable clamshell type computer in which the display unit 12 is attached to the computer body 11 so as to freely pivot between the opened position where the upper surface of the computer body 11 is exposed and the closed position where the upper surface of the computer body 11 is covered with the display unit 12, is assumed. However, the computer 10 may also be, for example, a slide type computer in which the display unit 12 slides and serves as a cover of the computer body 11.

The communication modules 42A and 42B may not be arranged on both sides of the touchpad 14, but may also be arranged, for example, inside the palm rest 40, under the touchpad 14 arranged at the central portion of the palm rest region shown in FIG. 1. In this case, the communication modules 42A and 42B starts the short-range wireless communication when, for example, the user executes the input operation on the keyboard 13 after the wearable apparatus 1 approaches the palm rest 40. As the short-range wireless communication module 42, for example, the BT module 120 can also be used.

As described above, in the present embodiment, the computer 10 including the display 31 attached to the computer body 11 having the upper surface on which the keyboard 13 is arranged can execute the contactless charging of and the short-range wireless communication with the wearable apparatus 1 (external device) proximate to the palm rest region, by using the contactless charging pads 41A and 41B, and the short-range wireless communication modules 42A and 42B arranged in the palm rest region on the upper surface in which the keyboard 13 is arranged. The contactless charging pads 41A and 41B, and the short-range wireless communication modules 42A and 42B are arranged at the positions where the user generally places the hands, i.e., the positions with which the wearable apparatus 1 worn on the user is brought into contact, when the user uses the computer 10, for example, the user executes the input operation by using the keyboard 13. For this reason, the user can, unconsciously, automatically execute the charging of the wearable apparatus 1 and the communication such as synchronous processing, etc. User's labor necessary to execute the charging and the communication can be thereby reduced. In addition, the user can execute the charging and the communication without detaching the wearable apparatus 1 from the user's wrist. The wearable apparatus 1 can also be used as an authentication apparatus. Even if the user uses a computer in which the contactless charging pads 41A and 41B or the short-range wireless communication modules 42A and 42B are not built, the user can, unconsciously, automatically execute the charging of the wearable apparatus 1 and the data synchronization processing by using the wrist rest 80 including the contactless charging pads 41A and 41B, and the short-range wireless communication modules 42A and 42B.

The function of the control program 202 described in the present embodiment may be implemented by exclusive LSI, DSP, or hardware such as a microcomputer.

Because the procedure for operation control processing of an embodiment can be realized by a computer program 202, an effect similar to that of the embodiment can easily be realized by installing and executing the computer program 202 through a computer readable storage medium storing the computer program 202 on a normal compatible computer.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a main body comprising an upper surface comprising a keyboard; and
a contactless charger in a palm rest on the upper surface, configured to charge an external apparatus by contactless charging.

2. The apparatus of claim 1, wherein
the external apparatus comprises a wearable apparatus on or near a user's wrist.

3. The apparatus of claim 1, further comprising a touchpad in the palm rest,
wherein the contactless charger comprises first and second contactless charging modules arranged on sides of the touchpad.

4. The apparatus of claim 1, wherein
the palm rest region is between the keyboard and an edge of the main body, and
the contactless charger is closer to the edge of the main body than to a middle portion between the keyboard and the edge of the main body.

5. The apparatus of claim 1, further comprising a short-range wireless communicator configured for short-range wireless communication with the external apparatus.

6. The apparatus of claim 1, further comprising:
a touchpad in the palm rest; and
first and second short-range wireless communicators on sides of the touchpad,
wherein the contactless charging module comprises first and second contactless charging modules on sides of the touchpad.

7. The apparatus of claim 5, further comprising a processor configured to synchronize data between the external apparatus and the electronic apparatus, by using the short-range wireless communication, in response to proximity of the external apparatus to the palm rest.

8. The apparatus of claim 5, further comprising an authentication controller configured to unlock the electronic apparatus when wireless connection between the external apparatus and the short-range wireless communicator is established and when the electronic apparatus is in a locked state.

9. The apparatus of claim 8, wherein the authentication controller is configured to lock the electronic apparatus when the external apparatus is not within a contactless-chargeable distance of the palm rest for a certain period.

10. The apparatus of claim 1, further comprising
a controller configured to deactivate a touch pad in the palm rest while the external apparatus is within a contactless-chargeable distance of the palm rest.

11. An electronic apparatus comprising:
a main body comprising an upper surface comprising a keyboard;
a touchpad in a palm rest; and
first and second short-range wireless communication modules on sides of the touchpad.

12. An electronic apparatus wearable on or near a wrist, comprising:
a battery; and
a local contactless charger configured to charge the battery by using electric power from an external contactless charger with a contactless-chargeable distance of the electronic apparatus.
